(19) United States
(12) Patent Application Publication
(10) Pub. No.: US 2011/0237127 A1
(43) Pub. Date: Sep. 29, 2011

(54) CONNECTOR AND ELECTRONIC EQUIPMENT

(75) Inventors: Takahisa OHTSUJI, Yao-shi (JP); Takayuki NAGATA, Yao-shi (JP)

(73) Assignee: HOSIDEN CORPORATION, Yao-shi (JP)

(21) Appl. No.: 13/043,863

(22) Filed: Mar. 9, 2011

(30) Foreign Application Priority Data
Mar. 26, 2010 (JP) 2010-072566
May 20, 2010 (JP) 2010-116038
May 21, 2010 (JP) 2010-117367

(51) Int. Cl. H01R 13/648

(52) U.S. Cl. 439/607.01

(57) ABSTRACT

The invention provide a connector including a body having an insulating property, a contact provided in the body, a tuboid shield case adapted to receive the body, and a reinforcing member. The shield case includes a bent portion being a portion of the shield case bent inward and extending in an insertion direction of the body, and a depression being provided on a backside of the bent portion and extending in the insertion direction. The reinforcing member is configured to fit in at least a part of the depression.

The present application claims priority under 35 U.S.C. §119 of Japanese Patent Application Nos. 2010-072566 filed on Mar. 26, 2010, 2010-116038 filed on May 20, 2010, and 2010-117367 filed on May 21, 2010, the disclosures of which are expressly incorporated by reference herein in their entity.

### BACKGROUND OF THE INVENTION

1. Technical Field

The present invention relates to a connector having a shield case and to electronic equipment having the same connector.

2. Background Art

A conventional connector of this type includes a rectangular tuboid shield case, a body received in the shield case, and contacts provided in the body, wherein the shield case has a top plate and a bottom plate opposed to the top plate, and the bottom plate is provided at its center with a bent portion that is bent toward the top plate into a generally U shape. The bent portion extends from an end to the opposite end along a body insertion direction so as to partition an internal space of the shield case into first and second slots each for fittingly receiving a mating connector (see Patent Literature 1).

### CITATION LIST

Patent Literature 1: Japanese Unexamined Patent Publication No. 2009-277497

### SUMMARY OF INVENTION

The shield case with the bent portion has a problem that the bent portion is vulnerable to prying force applied by a mating connector fitted in the first or the second slot and twisted in a circumferential direction. The prying force may cause deformation of the bent portion and its surrounding area.

The present invention has been devised in view of the above-described situation. The invention provides a connector having a bent portion that is less likely to deform if prying force is applied to the connector. The invention also provides electronic equipment having the same connector.

In view of the above-described problem, a connector of the present invention includes a body having an insulating property, a contact provided in the body, a tuboid shield case adapted to receive the body, and a reinforcing member. The shield case includes a bent portion being a portion of the shield case bent inward and extending in an insertion direction of the body, and a depression being provided on a backside of the bent portion and extending in the insertion direction. The reinforcing member is configured to fit in at least a part of the depression.

In the above-described connector, as the reinforcing member is configured to fit in at least a part of the depression on the back side of the bent portion, the bent portion and its surrounding area are less likely to deform if prying force is applied to the shield case by a mating connector inserted into the shied case. The invention makes it possible to improve the connector in prying resistance.

The reinforcing member may fit in the whole of the depression. The reinforcing member fit in the entire depression is further advantageous in minimizing deformation of the bent portion and its surrounding area, improving the prying resistance of the connector.

If the body includes a first surface in the insertion direction and a second surface on an opposite side of the first surface in the insertion direction, the reinforcing member may preferably project from the first surface of the body. The reinforcing member projectingly and integrally provided on the body is advantageous in reducing the number of components. Moreover, as the reinforcing member is provided on the first surface in the insertion direction of the body, it can be inserted into the depression when inserting the body into the shield case. Such configurations serve to reduce assembling man-hours of the connector.

The bent portion may partition an internal space of the shield case into first and second slots. Alternatively, the bent portion may function as a key portion that is insertable into a key groove of a mating connector.

The shield case may be an electrically conductive plate bent into a tuboid shape, and the shield case may further include a joining portion formed by joining end portions of the plate. In this case, the reinforcing member fitted in at least a part of the depression on the back side of the bent portion can prevent deformation of the bent portion and its surrounding area, thereby preventing the joining portion from getting disjoined and released open.

Electronic equipment of the present invention may include the above-described connector as an external interface.

### BRIEF DESCRIPTION OF DRAWINGS

FIGS. 1A and 1B are schematic perspective views of a connector according to a first embodiment of the present invention. FIG. 1A illustrates the connector as seen from the front, plan and right side, and FIG. 1B illustrates the connector as seen from the back, plan and right side.

FIGS. 2A to 2F are schematic views of the connector, where FIG. 2A is a front view, FIG. 2B is a back view, FIG. 2C is a plan view, FIG. 2D is a bottom view, FIG. 2E is a right side view, and FIG. 2F is a left side view.

FIG. 3A is a cross-sectional view of the connector taken along 3A-3A in FIG. 2A, FIG. 3B is a cross-sectional view of the connector taken along 3B-3B in FIG. 2A, FIG. 3C is a cross-sectional view of the connector taken along 3C-3C in FIG. 2A, and FIG. 3D is a cross-sectional view of the connector taken along 3D-3D in FIG. 2A.

FIG. 4 is an exploded perspective view of the connector as seen from the front, plan and right side.

FIG. 5 is an exploded perspective view of the connector as seen from the back, bottom and left side.

FIG. 6 is an explanatory view showing a state where pads of a shield case of the connector are connected to electrodes of a circuit board by soldering.

FIGS. 7A to 7C are plan views each showing a plug connector to be connected to the above connector. FIG. 7A illustrates an integrated plug connector, FIG. 7B illustrates a single plug connector to be connected to a first slot of the connector, and FIG. 7C illustrates a single plug connector to be connected to a second slot of the connector.

FIGS. 8A and 8B are schematic perspective views of a connector according to a second embodiment of the present invention. FIG. 8A is a perspective view of the connector as seen from the front, plan and right side, and FIG. 8B is a perspective view of the connector as seen from the back, plan and right side.

FIGS. 9A to 9F are schematic views of the connector, where FIG. 9A is a front view, FIG. 9B is a back view, FIG. 9C is a plan view, FIG. 9D is a bottom view, FIG. 9E is a right side view, and FIG. 9F is a left side view.

FIG. 10A is a cross-sectional view of the connector taken along 10A-10A in FIG. 9A, FIG. 10B is a cross-sectional view of the connector taken along 10B-10B in FIG. 9A, FIG. 100 is a cross-sectional view of the connector taken along 10C-10C in FIG. 9A, FIG. 10D is a cross-sectional view of the connector taken along 10D-10D in FIG. 9A, and FIG. 10E is a cross-sectional view of the connector taken along 10E-10E in FIG. 9A.

FIG. 11 is an exploded perspective view of the connector as seen from the front, plan and right side.

FIG. 12 is an exploded perspective view of the connector as seen from the back, bottom and left side.

FIG. 13 is a schematic front view showing a modified connector according to the present invention.

FIG. 14 is a schematic perspective view of a design modification of the connector according to the second embodiment as seen from the back, plan and right side.

### DESCRIPTION OF EMBODIMENTS

First and second embodiments of the present invention will be described below.

### First Embodiment

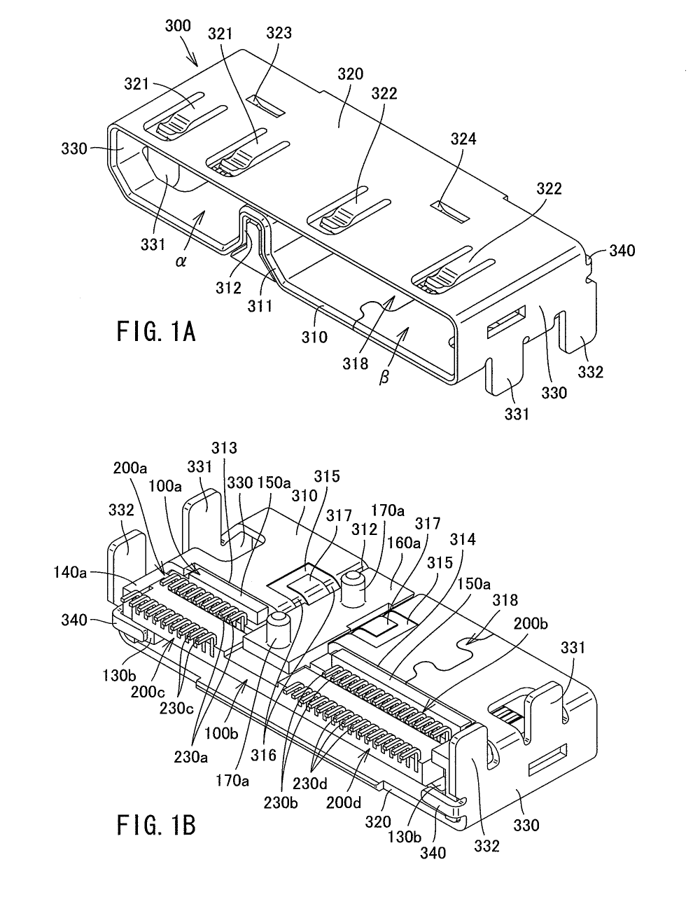

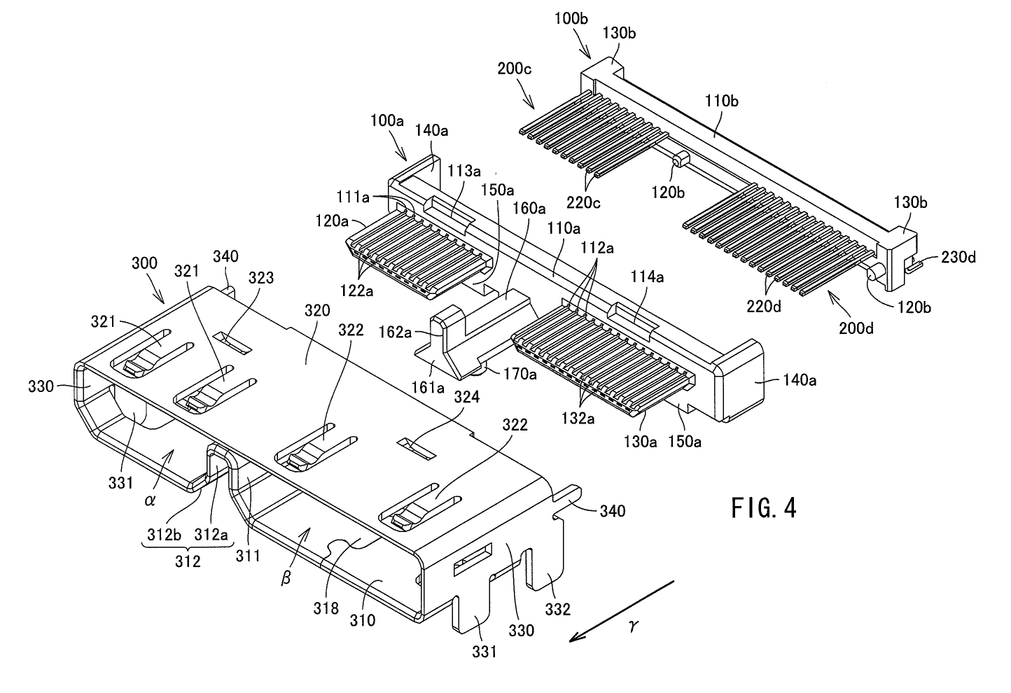

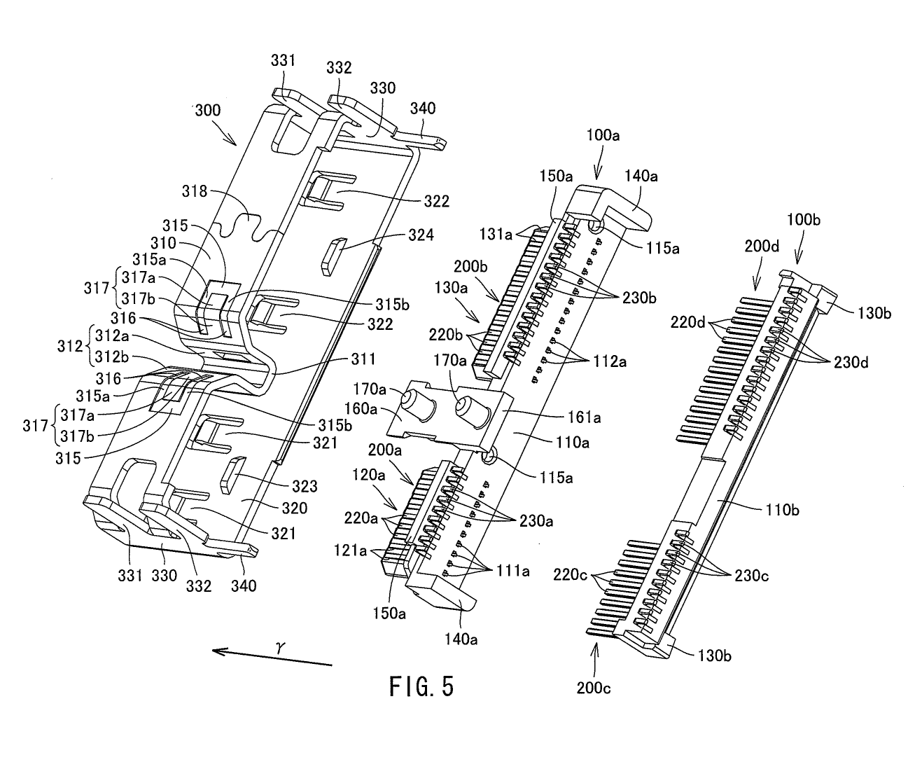

First, a receptacle connector according to a first embodiment of the present invention will be described with reference to FIGS. 1A to 7C. The receptacle connector shown in FIGS. 1A to 3D is a connector adapted to be mounted on a circuit board 10 of electronic equipment such as a television receiver and used as an external interface of the electronic equipment. The receptacle connector includes first and second bodies 100a, 100b, a plurality of first, second, third, fourth contacts 200a, 200b, 200c, 200d, and a shield case 300. These respective elements will be described in detail below. It should be noted that the direction to insert the first and second bodies 100a, 100b into an accommodating space (to be described) is indicated as an insertion direction γ in FIGS. 4 and 5.

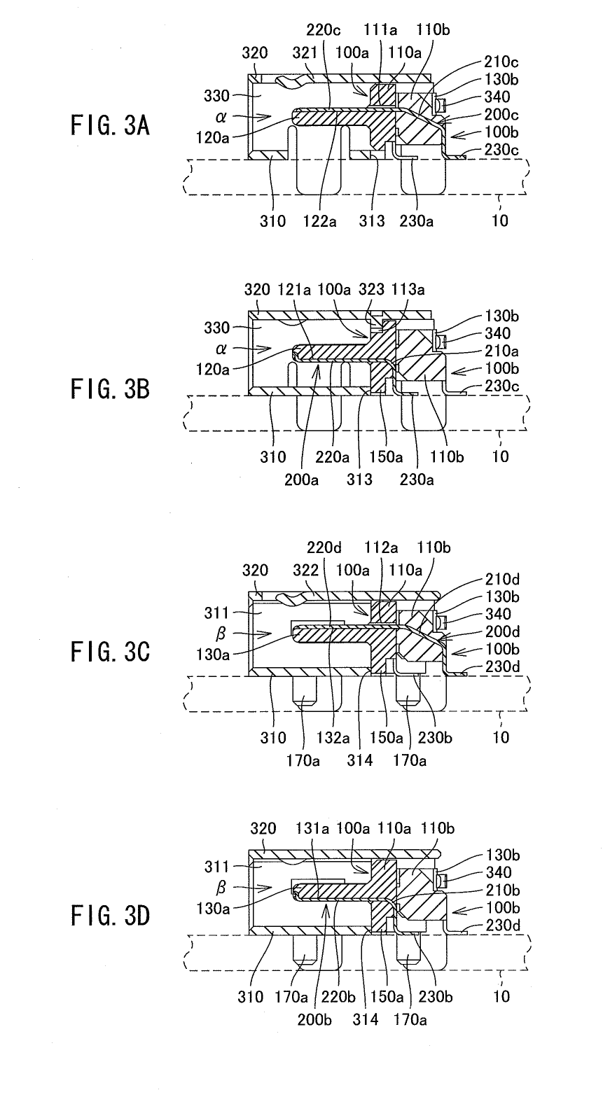

The shield case 300 is fabricated by press-molding a electrically conductive metal plate into a generally rectangular tuboid shape, as shown in FIGS. 1A to 5. The shield case 300 has a bottom plate 310, a top plate 320, a pair of side plates 330, and a pair of lock pieces 340. The bottom plate 310 is a generally rectangular plate opposed to the top plate 320, and an outer surface of the bottom plate 310 is adapted to be placed on the circuit board 10. The side plates 330 are provided upright at widthwise ends of the bottom plate 310. Upper ends of the side plates 330 are coupled by the top plate 320. The depth (length in the insertion direction γ) of the bottom plate 310 is shorter than each depth of the top plate 320 and the side plates 330, as shown in FIGS. 3A to 3D. The bottom plate 310, and a front portion of the top plate 320, and front portions of the side plates 330 define an internal space of the shield case 300, and rear portions of the top plate 320 and the side plates 330 define the accommodating space for accommodating the first and second bodies 100a, 100b inserted from a rear side.

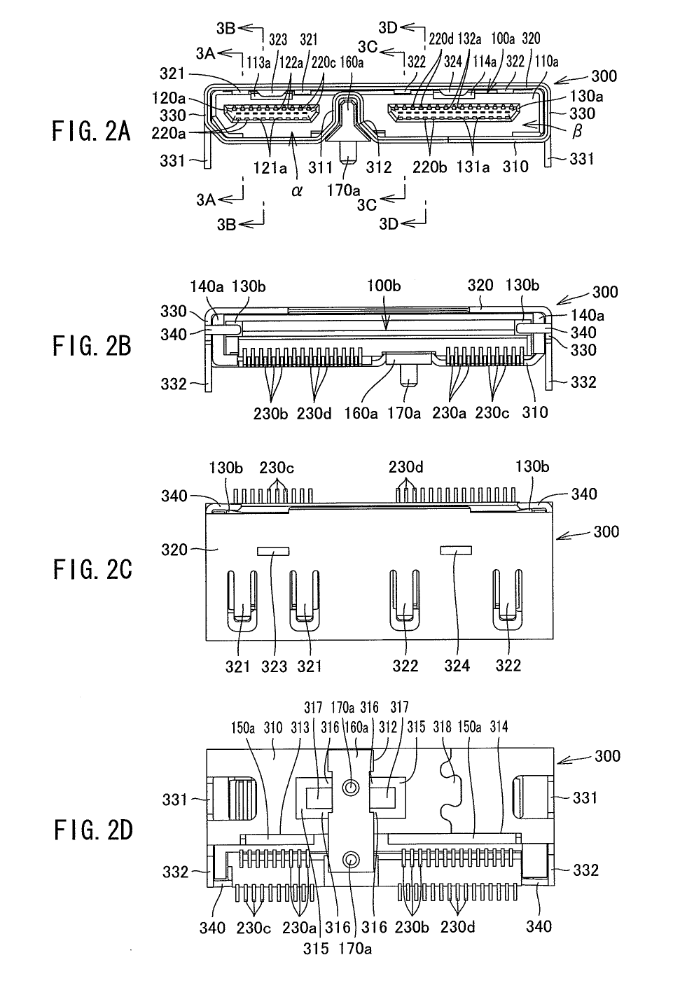

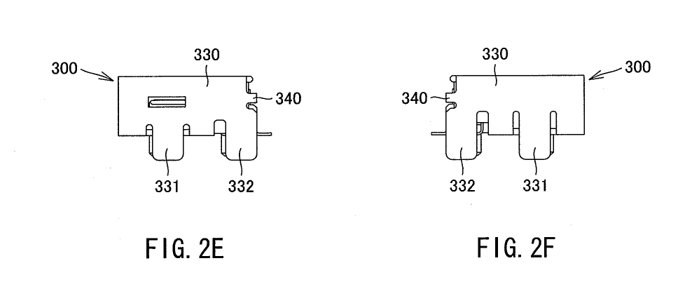

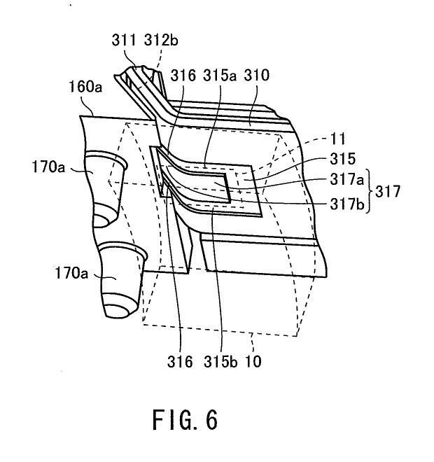

As shown in FIGS. 1A and 2A, the bottom plate 310 is bent at its central portion into a generally inverted U shape extending toward the top plate 320. The bent central portion serves as a partition 311 to partition the internal space of the shield case 300 into first and second slots α, β. The back side of the partition 311 forms a depression 312 having a generally inverted U-shaped cross section. The partition 311 and the depression 312 extend the entire depth of the bottom plate 310, i.e. from the front end to the rear end in the insertion direction γ of the bottom plate 310, as shown in FIG. 5. The depression 312 consists of a rectangular upper depression 312a and a lower depression 312b. The distance between the opposite walls of the lower depression 312b are gradually increased toward the lower end, such that the inner surfaces of the lower depression 312b are inclined with respect to the outer surface of the bottom plate 310. In the boundary areas of the outer surface of the bottom plate 310 with the inner surfaces of the lower depression 312b, there are formed generally U-shaped first recesses 315, each of which has first and second end portions 315a, 315b, as shown in FIGS. 5 and 6. In each of the first recesses 315, the opening between the first and second end portions 315a, 315b faces inward, i.e. toward the depression 312. In each of boundary areas of the inner surfaces of the lower depression 312b with the outer surface of the bottom plate 310, there is formed a pair of rectangular second recesses 316, communicating with the first and second end portions 315a, 315b of the first recess 315. Areas defined by the first and second recesses 315, 316 serve as pads 317 for connection by soldering with a pair of ground electrodes 11 of the circuit board 10. The pads 317 each have first and second pad portions 317a, 317b. The first pad portions 317a are provided in the outer surface of the bottom plate 310. The surfaces of the first pad portions 317a are located at the same height as (i.e. flush with) the outer surface of the bottom plate 310. The second pad portions 317b are provided in the inner surfaces of the lower depression 312b and inclined with respect to the first pad portions 317a. The surfaces of the second pad portions 317b are located at the same height as (i.e. flush with) the inner surfaces of the lower depression 312b. The ground electrodes 11 are generally rectangular surface electrodes, each having a contactable portion contactable to the first pad portion 317a and an extended portion extended from the contactable portion toward the second pad portion 317b side.

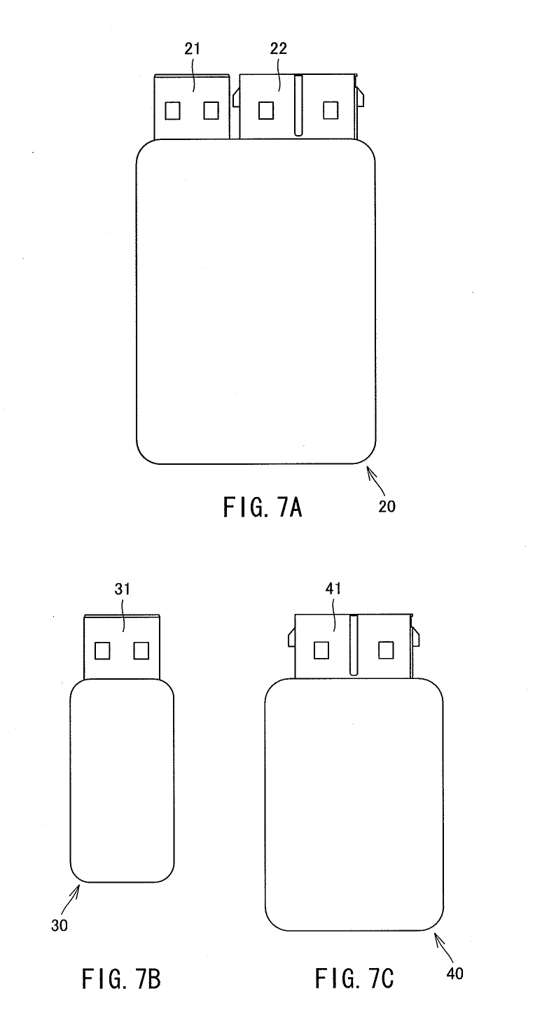

The bottom plate 310 has a joining portion 318 on the second slot β side. The joining portion 318 is a portion where end portions of a metal plate forming the shield case 300 are joined and swaged. Providing the joining portion of the shield case 300 on the second slot β side portion of the bottom plate 310 makes it possible to secure favorable strength of the first and second slot α, β portions of the shield case 300. The first slot α has an inner shape conforming to an outer shape of a connection portion 21 for HDMI (High-Definition Multimedia Interface, registered trademark) Type D of a plug connector 20, as shown in FIG. 7A, or a connection portion 31 for the HDMI Type D of a plug connector 30 as shown in FIG. 7B. The second slot β has an inner shape conforming to an outer shape of a connection portion 22 of another standard than HDMI of the plug connector 20, as shown in FIG. 7A, or a connection portion 41 of another standard than HDMI of a plug connector 40 as shown in FIG. 7C. That is, the first slot α is adapted to receive the connection part 21 or the connection part 31, and the second slot β is adapted to receive the connection part 22 or the connection part 41. Moreover, rear surfaces of the bottom plate 310, corresponding to first and second slot α and β, serve as abutting-stop surfaces 313, 314 to abut front surfaces of a pair of elongated protrusions 150a (to be described) of the first body 100a, as shown in FIGS. 3B to 3D.

The top plate 320 is a generally rectangular plate portion as shown in FIGS. 1A and 1B. The top plate 320 are cut at portions to form two locking pieces 321 and two locking pieces 322. Distal ends of the locking pieces 321, 322 are bent downward into circular arcs. When inserting a plug connector 20 or 30 into the first slot α, its connection part 21 or 31 is elastically contacted and held by the distal ends of the locking pieces 321. Similarly, when inserting a plug connector 20 or 40 into the second slot β, its connection part 21 or 41 is elastically contacted and held by the distal ends of the locking pieces 322. Moreover, the top plate 320 are partially cut at portions posterior to the locking pieces 321, 322 and depressed downward to form abutting-stops 323, 324.

A lower end of each of the side plates 330 is provided with a front terminal 331 and a rear terminal 332 extended downward. The front terminals 331 are formed by partly cutting opposite widthwise end portions of the bottom plate 310 and bending these cut parts downward. The rear terminals 332 are formed by cutting and bending downward portions of the cut-away area of the bottom plate 310, which portions are reserved before cutting away the cut-away area to make the depth dimension of the bottom plate 310 smaller than the top plate 320 and the side plates 330. The front terminals 331 and the rear terminals 332 are to be inserted into through-hole electrodes (not shown) of the circuit board 10. The lock pieces 340 are extended from rear ends of the side plates 330.

The first body 100a is an injection-molded article of insulating resin. The first body 100a has a main body 110a, first and second projected portions 120a, 130a, a pair of guides 140a, the pair of elongated protrusions 150a, a reinforcing member 160a, and a pair of locking projections 170a, as shown in FIGS. 3A to 5. The main body 110a is a plate having a rectangular cross-section. The main body 110a has a plurality of first and second holes 111a, 112a formed in the insertion direction γ through the main body 110a and arranged at spaced intervals in a row along the width of the first body 100a. As shown in FIGS. 3A to 3D and FIG. 4, cutaways 113a, 114a are provided in an upper end portion of a front surface in the insertion direction γ of the main body 110a. The cutaways 113a, 114a are adapted to receive the abutting-stops 323, 324 of the shield case 300, so that the abutting-stops 323, 324 abut back surfaces of the cutaways 113a, 114a from the front side.

The front surface in the insertion direction γ of the main body 110a (first surface of the body) is provided with the plate-like first and second projected portions 120a, 130a to be inserted into the first and second slots α, β. The first and second projected portions 120a, 130a have such outer shapes as to fit in connection holes (not shown) of the connection parts 21, 22 of the plug connector 20 shown in FIG. 7A. The lower surfaces of the first, second projected portions 120a, 130a has a plurality of first and second long grooves 121a, 131a at spaced intervals in a row in the width direction. The upper surfaces of the first and second projected portions 120a, 130a has a plurality of third and fourth long grooves 122a, 132a at spaced intervals in a row in the width direction, in communication with the first and second holes 111a, 112a, respectively. The first, second, third and fourth long grooves 121a, 131a, 122a, 132a extend in the insertion direction γ. Each of the third long grooves 122a is located in plan position between adjacent first long grooves 121a. Each of the fourth long grooves 132a is located in plan position between adjacent second long grooves 131a. In other words, as shown in FIG. 2A, the first long grooves 121a and the third long grooves 122a are arranged in a zigzag manner, and the second long grooves 131a and the fourth long grooves 132a are arranged in a zigzag manner.

The reinforcing member 160a of generally L-shape is provided centrally at a lower end of the front surface of the main body 110a, as shown in FIG. 4. The reinforcing member 160a has an arm 161a of generally triangular prism shape and a projection 162a of rectangular prism shape. The arm 161a is a generally triangular prism extending forward from the front of the main body 110a. The projection 162a is a rectangular prism projecting upward from the distal end of the arm 161a. The projection 162a fits in the upper depression 312a of the depression 312 of the shield case 300, and the arm 161a fits in the lower depression 312b of the depression 312. The reinforcing member 160a thus fits in a part of the depression 312 of the shield case 300. The pair of columnar locking projections 170a is provided on the lower surface of the arm 161a. The locking projections 170a are to be inserted into locking holes (not shown) of the circuit board 10.

As shown in FIG. 5, in the main body 110a, the plurality of first and second contacts 200a, 200b are arrayed at spaced intervals in a row in the width direction. Each of the first contacts 200a is a conductive elongated metal plate as shown in FIG. 3B and has an embedded portion 210a, a contact portion 220a and a tail portion 230a. The embedded portion 210a is a generally inverted L-shaped and embedded in the main body 110a, and a rear end portion thereof projects downward from the main body 110a. The contact portion 220a extends straight continuously from a distal end of the embedded portion 210a and is received in one of the first long grooves 121a of the first projected portion 120a. The tail portion 230a is a flat plate continuing to a rear end of the embedded portion 210a and bent at a right angle with respect to the rear end portion of the embedded portion 210a. Each of the second contacts 200b is a conductive elongated metal plate as shown in FIG. 3D and has an embedded portion 210b, a contact portion 220b, and a tail portion 230b. The second contacts 200b have the same configuration as the first contacts 200a, except that the contact portions 220b are to be received in the second long grooves 131a of the second projected portion 130a. As such, the respective portions of the second contacts 200b will not be further described with regard to overlap with the first contacts 200a.

The pair of elongated protrusions 150a is provided on the lower surface of main body 110a. The elongated protrusions 150a are adapted to abut the abutting-stop surfaces 313, 314 of the bottom plate 310 of the shield case 300 from the front side. The pair of guides 140a is provided at the widthwise ends of a rear surface in the insertion direction γ of the main body 110a. The top surfaces of the guides 140a are adapted to abut the top plate 320 of the shield case 300, improving the degree of parallelism of the combined first and second bodies 100a and 100b in relation to the top plate 320 of the shield case 300. As shown in FIG. 5, the rear surface of the main body 110a has fitting holes 115a, one between the first and second holes 111a and 112a and the other outside the second holes 112a.

The second body 100b is an injection-molded article of insulating resin, as shown in FIGS. 3A to 5. The second body 100b has a main body 110b, a pair of fitting projections 120b, and a pair of hills 130b. The main body 110b has a generally L-shaped cross-section, and its width is a little smaller than a distance between the guides 140a of the first body 100a. When the second body 100b is inserted between the guides 140a of the first body 100a, the first and second bodies 100a, 100b are combined anteroposteriorly in the insertion direction γ. As shown in FIG. 4, the front surface of the main body 110b has the pair of fitting projections 120b at corresponding positions to the fitting holes 115a. The fitting projections 120b are columnar projections to fit in the fitting holes 115a of the first body 100a. The fit between the fitting projections 120b and the fitting holes 115a allows the first and second bodies 100a, 100b to be maintained in a combined state. The pair of hills 130b is provided at widthwise ends of a rear surface in the insertion direction γ of the main body 110b. The hills 130b have enough height for their tips to project rearward from the guides 140a of the first body 100a with the first and second bodies 100a, 100b combined. The tips of the hills 130 abut the lock pieces 340 of the shield case 300 bent into generally L shapes. As a result, the first and second bodies 100a, 100b accommodated in the accommodating space of the shield case 300 are securely sandwiched between the lock pieces 340 and front abutting portions (namely, the partition 311 and the abutting-stop surfaces 313, 314 of the bottom plate 310, and the abutting-stops 323, 324 of the top plate 320). The first and second bodies 100a, 100b are thus fixed inside the accommodating space. It is appreciated that FIGS. 4 and 5 illustrates the lock pieces 340 in a straightened state before bent.

In the main body 110b, as shown in FIG. 4, the plurality of third and fourth contacts 200c, 200d are arrayed in a row in the width direction and at the same spaced intervals as those of the first and second holes 111a, 112a, respectively. The third and fourth contacts 200c, 200d are located above the first and second contacts 200a, 200b (i.e., at a different height position). Each of the third contacts 200c is a conductive elongated metal plate as shown in FIG. 3A and has an embedded portion 210c, a contact portion 220c, and a tail portion 230c. The embedded portion 210c is embedded in the main body 110b and has an obliquely inclined intermediate portion, and a distal portion bent with respect to the intermediate portion, and a rear portion bent with respect to the intermediate portion and extended downward. The distal portion and the intermediate portion of the embedded portion 210c are embedded in the main body 110b. The rear end portion of the embedded portion 210c projects downward from the main body 110b. The contact portion 220c is a flat plate continuing to the distal end of the embedded portion 210c and projecting from the front surface of the main body 110b. The contact portion 220c is longer than the first contact portion 220a by a thickness of the main body 110a of the first body 100a. The contact portion 220c is to be received in one of the first holes 111a and one of the third long grooves 122a of the first body 100a. The tail portion 230c is a flat plate continuing to a rear end of the embedded portion 210c and bent at a right angle with respect to the rear end of the embedded portion 210c. Each of the fourth contacts 200d is a conductive elongated metal plate as shown in FIG. 3C and has an embedded portion 210d, a contact portion 220d, and a tail portion 230d. The fourth contacts 200d have the same configuration as the third contacts 200c, except that the contact portions 220d are to be received in the second holes 112a of the first body 100a and in the fourth long groove 132a of the second projection 130a. As such, the respective portions of the fourth contacts 200d will not be further described with regard to overlap with the third contacts 200c.

The contact portions 220a received in the first long grooves 121a and the contact portions 220c received in the third long grooves 122a are arranged in a zigzag manner. In other words, each of the contact portions 220c of the third contacts 200c is at a plan position between adjacent ones of contact portions 220a of the first contacts 200a. The contact portions 220a, 220c thus arranged are inserted into the first slot α together with the first projected portion 120a, in a contactable manner with lower and upper contacts of the connection part 21 or 31 of a plug connector 20 or 30 inserted into the first slot α. Similarly, the contact portions 220b received in the second long grooves 131a and the contact portions 220d received in the fourth long grooves 132a are arranged in a zigzag manner. In other words, each of the contact portions 220d of the fourth contacts 200d is at a plan position between adjacent ones of the contact portions 220b of the second contacts 200b. The contact portions 220b, 220d thus arranged are inserted into the second slot β together with the second projected portion 130a, in a contactable manner with lower and upper contacts of the connection part 22 or 41 of a plug connector 20 or 40 inserted into the second slot β. Moreover, lower surfaces of the tail portions 230a, 230c are located at the same height, and the tail portions 230a, 230c are arrayed in two anteroposterior rows in the insertion direction γ. Also, lower surfaces of the tail portions 230b, 230d are located at the same height, and the tail portions 230b, 230d are arrayed in two anteroposterior rows in the insertion direction γ. The tail portions 230a, 230b, 230c, 230d are connectable by soldering to associated surface electrodes (not shown) of the circuit board 10.

The receptacle connector having the above-described configuration may be assembled in the following steps. First, as shown in FIGS. 4 and 5, the embedded portions 210a, 210b of the first and second contacts 200a, 200b are embedded in the first body 100a by insert molding, and the embedded portions 210c, 210d of the third and fourth contacts 200c, 200d are embedded in the second body 100b by insert molding. The embedded first and second contacts 200a, 200b will be arrayed in a row in the width direction in the first body 100a, and the embedded third and fourth contacts 200c, 200d will be arrayed in a row in the width direction in the second body 100b. Simultaneously, the contact portions 220a, 220b of the first and second contacts 200a, 200b are inserted into the first and second long grooves 121a, 131a, respectively, of the first body 100a.

Thereafter, the first and second bodies 100a, 100b are brought relatively closer to each other, and the contact portions 220c, 220d of the third and fourth contacts 200c, 200d of the second body 100b are inserted into the first and second holes 111a, 112a and the third and fourth long grooves 122a, 132a of the first body 100a. As a result, the contact portions 220a and the contact portions 220c are arranged at the different height positions in a zigzag manner, and the contact portions 220b and the contact portions 220d are arranged at the different height positions in a zigzag manner. Simultaneously, the second body 100b is inserted between the pair of guides 140a of the first body 100a, using the guides 140a of the first body 100a to guide the widthwise ends of the second body 100b. The fitting projections 120b of the second body 100b are fitted in the fitting holes 115a of the first body 100a. Consequently, the first and second bodies 100a, 100b are combined anteroposteriorly in the insertion direction γ, so that the tail portions 230a, 230c are arranged at the same height in two anteroposterior rows in the insertion direction γ, and the tail portions 230b, 230d are arranged at the same height in two anteroposterior rows in the insertion direction γ.

Thereafter, the reinforcing member 160a of the first body 100a is inserted into the depression 312 of the shield case 300, to fit the projection 161a of the reinforcing member 160a in the upper depression 312a of the depression 312 and the arm 162a thereof in the lower depression 312b. During this insertion, the reinforcing member 160a is guided by the depression 312 along the insertion direction γ, and the first and second bodies 100a, 100b are received between the lock pieces 340 as straightened along the side plates 330. The first and second bodies 100a, 100b are inserted along the insertion direction γ, from the rear side into the accommodating space of the shield case 300, while the widthwise ends of the first body 100a are guided by the lock pieces 340, and the first and second projected portions 120a, 130a of the first body 100a are inserted into the first and second slots α, β of the shield case 300. Consequently, the front surface of the main body 110a of the first body 100a abuts the partition 311; the elongated protrusions 150a of the first body 100a abut the respective abutting-stop surfaces 313, 314 of the bottom plate 310 of the shield case 300; and the abutting-stops 323, 324 of the top plate 320 of the shield case 300 are received from the front side into the cutaways 113a, 114a of the first body 100a and abut the back surfaces of the cutaways 113a, 114a. The guides 140a of the first body 100a abut the top plate 320 of the shield case 300.

In this state, the lock pieces 340 are bent inward to abut the respective hills 130b of the second body 100b. Consequently, the first and second bodies 100a, 100b are securely sandwiched between the lock pieces 340 and the front abutting portions, so that the first and second bodies 100a, 100b are fixedly accommodated in the accommodating space of the shield case 300.

The receptacle connector may be thus assembled and may be mounted on the circuit board 10 in the following manner. First, the front terminals 331 and the rear terminals 332 of the shield case 300 are inserted into the through-holes of the circuit board 10. Simultaneously, the locking projections 170a of the first body 100a are inserted into and locked against the locking holes of the circuit board 10. Consequently, the outer surface of the bottom plate 310 of the shield case 300 is placed on the circuit board 10, so that the pads 317 of the shield case 300 come into contact with the pair of ground electrodes 11 of the circuit board 10, and the tail portions 230a, 230b, 230c, 230d are placed on the surface electrodes of the circuit board 10. Thereafter, the front terminals 331 and the rear terminals 332 are soldered to the through-hole electrodes of the circuit board 10, the pads 317 are soldered to the pair of ground electrodes 11, and the tail portions 230a, 230b, 230c, 230d are soldered to the surface electrodes of the circuit board 10. Solder fillets are thus formed between the second pad portions 317b of the pads 317 and the ground electrodes 11. The shield case 300 is electrically connected to a ground line of the circuit board 10 through the through-hole electrodes and the ground electrodes 11 of the circuit board 10, so that the shield case 300 is able to function as a shield.

In the above-described receptacle connector, the reinforcing member 160a is partially fitted in the depression 312 on the back side of the partition 311 of the shield case 300. If prying force is applied on the connector by the connection portion 31 of the plug connector 30 inserted into the slot a or by the connection portion 41 of the plug connector 40 inserted into the slot β, it is unlikely that the partition 311 and its surrounding area deform and that the joining portion 318 gets disjoined and released open. Therefore, the connector advantageously has improved prying resistance. Further, the reinforcing member 160a projects from the front surface of the main body 110a of the first body 100a, the reinforcing member 160a can be fitted in the depression 312 of the shield case 300 when inserting the first and second bodies 100a, 100b into the shield case 300. The above configuration can reduce assembling man-hours of the present connector.

Moreover, no clearance is produced between the outer surface of the bottom plate 310 and the circuit board 10 when the outer surface of the bottom plate 310 is placed on the circuit board 10. This is because the first recesses 315 are formed in the outer surface of the bottom plate 310 of the shield case 300, and the second recesses 316 are formed in the opposite inner surfaces of the lower depression 312b of the depression 312 on the back side of the partition 311; the portions defined by the first and second recesses 315, 316 function as the pads 317; and the first pad portions 317a of the pads 317 are coplanar with the outer surface of the bottom plate 310. Further advantageously, as the first pad portions 317a are surrounded by the substantially U-shaped first recesses 315, which minimizes unfavorable spread of solder into other areas of the outer surface of the bottom plate 310 facing the circuit board 10, and which minimizes intrusion of solder into the shield case 300 through the joining portion 318 of the bottom plate 310. The second pad portions 317b of the pads 317 are inclined with respect to the first pad portions 317a, allowing to form large solder fillets by applying solder to the second pad portions 317b. The present connector thus has an improved peel strength between its central portion and the circuit board. The present connector thus has an improved peel strength also between its end portions and the circuit board because the front terminals 331 and the rear terminals 332 of the shield case 300 are connected to the through-hole electrodes of the circuit board 10 by soldering. In summary, the present receptacle connector as a whole has such a configuration as to provide high peel strength from the circuit board.

Moreover, the nonexistence of clearance between the outer surface of the bottom plate 310 and the circuit board 10 is also favorable in reducing the mounting height of the receptacle connector. Furthermore, as the pads 317 are surrounded by the first and second recesses 315, 316, no openings are formed in the outer surface of the bottom plate 310 or in the inner surfaces of the lower depression 312b of the depression 312 on the back side of the partition 311, unlike a case where connection terminals are formed by cutting and downwardly bending portions of the shield case. The nonexistence of openings can thus prevent intrusion of solder and flux into the shield case 300 through the central portion or the partition 311 of the bottom plate 310 during soldering connection process. The nonexistence of openings in the central portion or the partition 311 of the bottom plate 310 is also advantageous in securing favorable prying resistance of the shield case 300.

### Second Embodiment

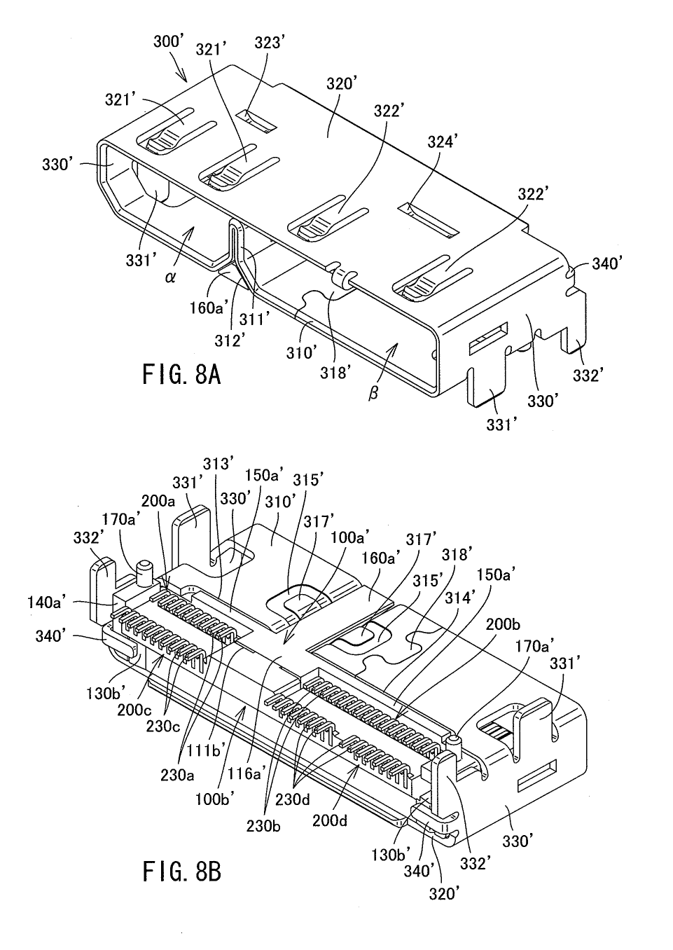

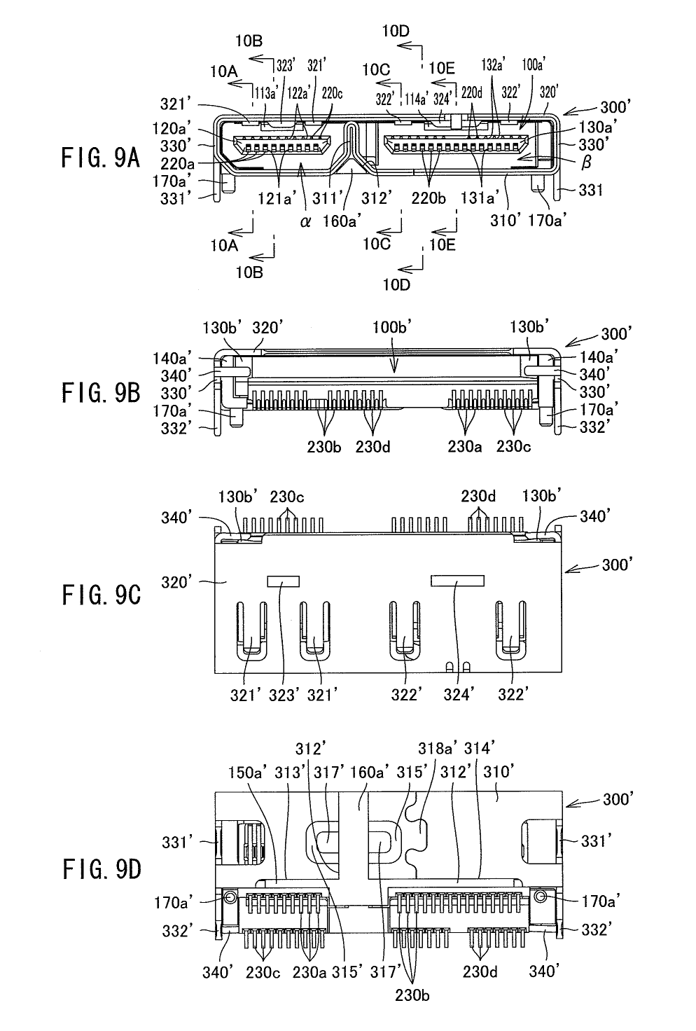

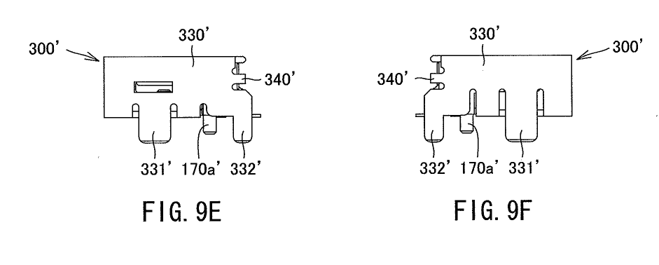

Next, a second embodiment of the invention will be described with reference to FIGS. 7A to 12. Similarly to the receptacle connector of the first embodiment, the receptacle connector shown in FIGS. 8A to 9F is to be mounted on the circuit board 10 of electronic equipment, such as a television receiver, and used as an external interface of the electronic equipment. This receptacle connector is substantially the same as the receptacle connector of the first embodiment, except that first and second bodies 100a′ and 100b′ and a shield case 300′ have different shapes from those of the first and second bodies 100a, 100b and of the shield case 300. Descriptions made hereinafter focus on the differences, not on overlapping features. It is to be noted that elements of the first and second bodies and the shield case are introduced with reference numerals added with an apostrophe (′) to distinguish them from the elements of the first and second bodies and the shield case of the first embodiment.

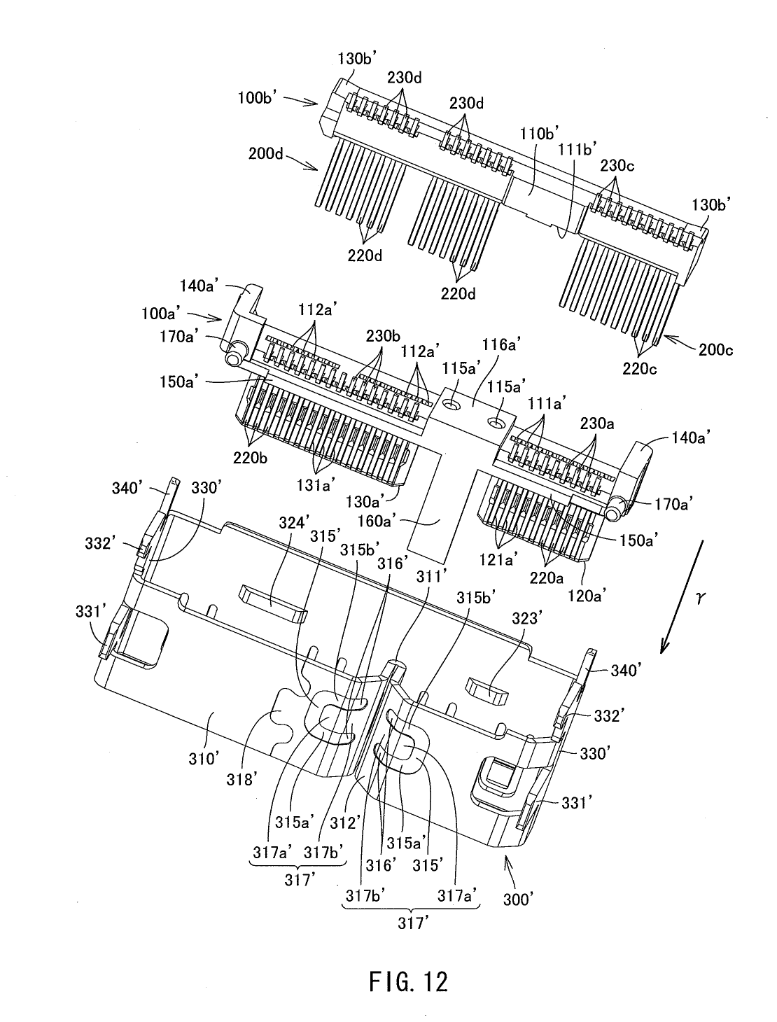

The shield case 300′ is different from the shield case 300 of the first embodiment in shapes of a partition 311′ and a depression 312′ of a bottom plate 310′. Descriptions made hereinafter focus on the differences. As shown in FIGS. 8A to 12, the bottom plate 310′ is bent at a central portion thereof into an inverted Y shape. The central portion serves as the partition 311′ having an inverted Y-shaped cross section, which partitions an internal space of the shield case 300′ into the first and second slots α, β. The back side of the partition 311′ forms the depression 312′ (depressed surface of the partition) having a substantially triangular cross section. The partition 311′ and the depression 312′ extend the entire depth of the bottom plate 310, i.e. from the front end to the rear end in the insertion direction γ of the bottom plate 310, as shown in FIG. 12. Both inner surfaces of the depression 312′ are inclined with respect to an outer surface of the bottom plate 310′. In the boundary areas of the outer surface of the bottom plate 310′ with the inner surfaces of the depression 312′, there are formed generally U-shaped first recesses 315′, each of which has first and second end portions 315a′, 315b′. In each of the first recesses 315′, the opening between the first and second end portions 315a, 315b faces inward, i.e. toward the depression 312′. In each of boundary areas of the inner surfaces of the depression 312′ with the outer surface of the bottom plate 310′, there is formed a pair of rectangular second recesses 316′, communicating with the first and second end portions 315a′, 315b′ of the first recesses 315′. Areas defined by the first and second recesses 315′, 316′ serve as pads 317′ for connection by soldering with the pair of ground electrodes 11 of the circuit board 10. The pads 317′ each have first and second pad portions 317a′, 317b′. The first pad portions 317a′ are provided in the outer surface of the bottom plate 310′. The surfaces of the first pad portions 317a′ are located at the same height as (i.e. flush with) the outer surface of the bottom plate 310′. The second pad portions 317b′ are provided in the inner surfaces of the depression 312′ and inclined with respect to the first pad portions 317a′. The surfaces of the second pad portions 317b′ are located at the same height as (i.e. flush with) the inner surfaces of the depression 312′. FIGS. 8A to 12 also illustrate a joining portion 318′, a top plate 320′, side plates 330′, lock pieces 340′, locking pieces 321′ and 322′, abutting-stops 323′ and 324′, front terminals 331′, and rear terminals 332′.

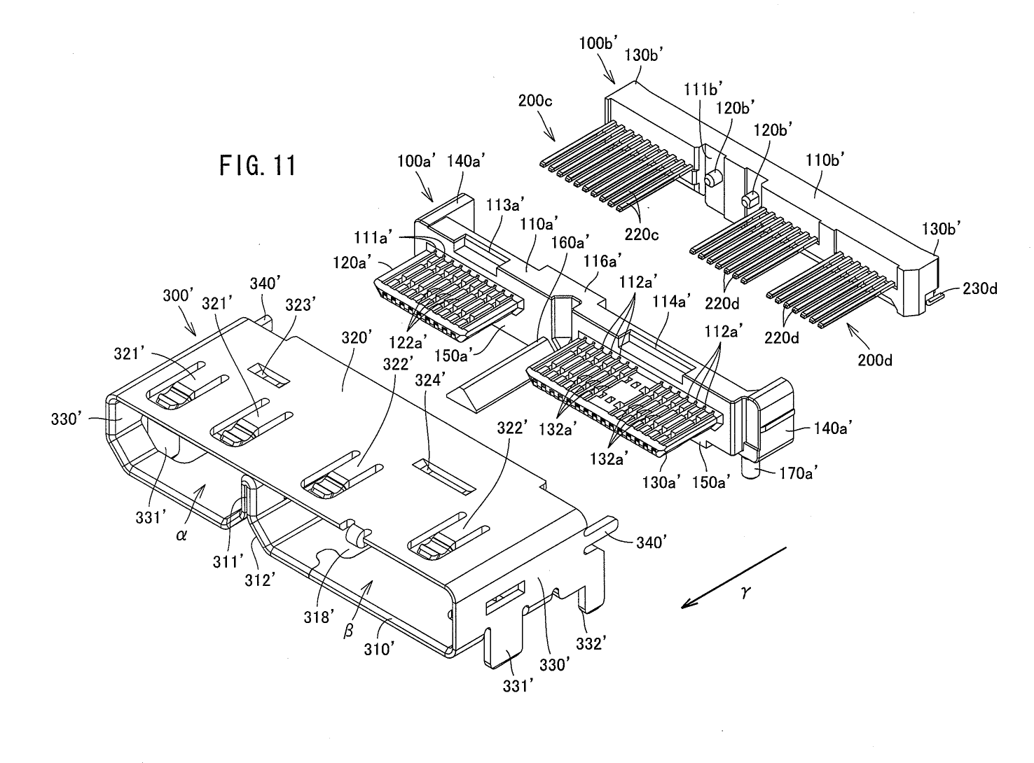

The first body 100a′ is different from the first body 100a of the first embodiment in arrays of second holes 112′ of a main body 110a′ and fourth long grooves 132′ of a second projected portion 130a′, positions of fitting holes 115a′ of the main body 110a′, a newly provided fitting projection 116a′ in the main body 110a′, a shape of a reinforcing member 160a′, and positions of a pair of locking projections 170a′. Descriptions made hereinafter focus on the differences. As shown in FIGS. 11 and 12, the main body 110a′ has the second holes 112a′ arrayed at spaced intervals with a wider interval in the middle of the array, and the second projected portion 130a′ has the fourth long grooves 132a′ at spaced intervals with a wider interval in the middle of the array. Accordingly, the same wider interval is provided in the middle of the row of the fourth contacts 200d, embedded portions 210d of which are embedded with the wider interval in the main body 110b′ of the second body 100b′. The reinforcing member 160a′ is a generally triangular prismatic arm projecting from a front surface of the main body 110a′. The length of the reinforcing member 160a′ is the same as the length in the insertion direction γ of the depression 312′, i.e., the reinforcing member 160a′ fits in the entire depression 312′. The locking projections 170a′ project from lower surfaces of a pair of guides 140a′. The locking projections 170a′ are to be received and locked in the locking holes (not shown) of the circuit board 10. The fitting projection 116a′ is a rectangular parallelepiped projection projected in the center of a rear end surface of the main body 110a′. The pair of fitting holes 115a′ is formed in a rear surface of the fitting projection 116a′. FIGS. 9A to 12 also illustrate a first projected portion 120a′, elongated protrusions 150a′, first holes 111a′, cutaways 113a′ and 114a′, first long grooves 121a′, second long grooves 122a′, and third long grooves 131a′.

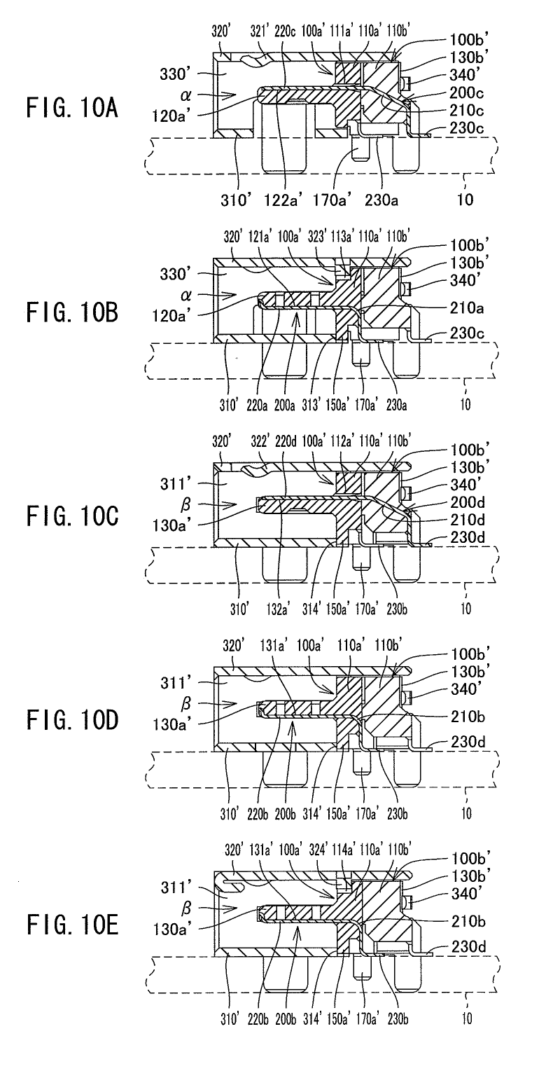

The second body 100b′ is different from the second body 100b of the first embodiment in a newly provided fitting depression 111b′ formed in the center of a front surface in the insertion direction γ of the main body 110b′, and positions of fitting projections 120b′. Descriptions made hereinafter focus on the differences. The fitting depressions 111b′ are generally rectangular and adapted to fittingly receive the fitting projection 116a′. The pair of fitting projections 120b′ is provided in the bottom of the fitting depression 111b′. The fitting projections 120b′ are to fit in the fitting holes 115a′ in the rear surface of the fitting projection 116a′. The main body 110b′ and hills 130b′ abut the lower surface of the top plate 320′ of the shield case 300′ as shown in FIGS. 10A to 10D.

The receptacle connector having the above-described configuration may be assembled in the following steps. First, as shown in FIGS. 11 and 12, the embedded portions 210a, 210b of the first and second contacts 200a, 200b are embedded in the first body 100a′ by insert molding, and the embedded portions 210c, 210d of the third and fourth contacts 200c, 200d are embedded in the second body 100b′ by insert molding. The embedded first and second contacts 200a, 200b are arrayed in a row in the width direction in the first body 100a′, and the third and fourth contacts 200c, 200d are arrayed in a row in the width direction in the second body 100b′. Simultaneously, the contact portions 220a, 220b of the first and second contacts 200a, 200b are inserted into the first and second long grooves 121a′, 131a′ of the first body 100a′.

Thereafter, the first and second bodies 100a′, 100b′ are brought relatively closer to each other, and the contact portions 220c, 220d of the third and fourth contacts 200c, 200d of the second body 100b′ are inserted into the first and second holes 111a′, 112a′ and the third and fourth long grooves 122a′, 132a′ of the first body 100a′. As a result, the contact portions 220a and the contact portions 220c are arranged at different height positions in a zigzag manner, and the contact portions 220b and the contact portions 220d are arranged at the different height positions in a zigzag manner. Simultaneously, the second body 100b′ is inserted between the pair of guides 140a′ of the first body 100a′, using the guides 140a′ of the first body 100a′ to guide the widthwise ends of the second body 100b′. Consequently, the fitting projection 116a′ of the first body 100a′ fits in the fitting depression 111b′ of the second body 100b′ and the fitting projections 120b′ of the second body 100b′ fits in the fitting holes 115a′ of the first body 100a′. Consequently, the first and second bodies 100a′, 100b′ are combined anteroposteriorly in the insertion direction γ, so that the tail portions 230a, 230c are arranged at the same height in two anteroposterior rows in the insertion direction γ, and the tail portions 230b, 230d are arranged at the same height in two anteroposterior rows in the insertion direction γ.

Thereafter, the reinforcing member 160a′ of the first body 100a′ is fittingly inserted into the depression 312′ of the shield case 300′. During this insertion, the reinforcing member 160a′ is guided by the depression 312′ along the insertion direction γ. The first and second bodies 100a′, 100b′ are simultaneously inserted between the lock pieces 340′ as straightened along the side plates 330′. Simultaneously, the first and second bodies 100a′, 100b′ are inserted along the insertion direction γ, from the rear side into the accommodating space of the shield case 300′ while the widthwise ends of the first body 100a′ are guided by the lock pieces 340′, and the first and second projected portions 120a′, 130a′ of the first body 100a′ are inserted into the first and second slots α, β of the shield case 300′. Consequently, the front surface of the main body 110a′ of the first body 100a′ abuts the partition 311′; the elongated protrusions 150a′ of the first body 100a′ abut the respective abutting-stop surfaces 313′, 314′ of the bottom plate 310′ of the shield case 300′; and the abutting-stops 323′, 324′ of the top plate 320′ of the shield case 300′ are received from the front side in the cutaways 113a′, 114a′ of the first body 100a′ and abut back surfaces of the cutaways 113a′, 114a′. The guides 140a′, the main body 110b′ and the hills 130b′ abut the top plate 320′ of the shield case 300′.

In this state, the lock pieces 340′ are bent inward to abut the hills 130b′ of the second body 100b′. Consequently, the first and second bodies 100a′, 100b′ are securely sandwiched between the lock pieces 340′ and front abutting portions (namely, the partition 311′ and the abutting-stop surfaces 313′, 314′ of the bottom plate 310′ and the abutting-stops 323′, 324′ of the top plate 320′), so that the first and second bodies 100a′, 100b′ are fixedly accommodated in the accommodating space of the shield case 300′.

The receptacle connector may be thus assembled and may be mounted on the circuit board 10 in a similar manner to the first embodiment. First, the front terminals 331′ and the rear terminals 332′ of the shield case 300′ are inserted into the above-mentioned through-hole electrodes of the circuit board 10. Simultaneously, the locking projections 170a′ of the first body 100a′ are inserted into and locked against the locking holes of the circuit board 10. Consequently, the outer surface of the bottom plate 310′ of the shield case 300′ is placed on the circuit board 10, so that the pads 317′ of the shield case 300′ come into contact with the pair of ground electrodes 11 of the circuit board 10, and the tail portions 230a, 230b, 230c, 230d come into contact with the surface electrodes of the circuit board 10. Thereafter, the front terminals 331′ and the rear terminals 332′ are soldered to the through-hole electrodes of the circuit board 10, the pads 317′ are soldered to the pair of ground electrodes 11, and the tail portions 230a, 230b, 230c, 230d are soldered to the surface electrodes of the circuit board 10. Solder fillets are thus formed between the second pad portions 317b′ of the pads 317′ and the ground electrodes 11.

In the above-described receptacle connector, the reinforcing member 160a′ is fitted in the depression 312′ on the back side of the partition 311′ of the shield case 300′. If prying force is applied on the connector by the connection portion 31 of the plug connector 30 inserted into the slot a or by the connection portion 41 of the plug connector 40 inserted into the slot β, it is unlikely that the partition 311′ and its surrounding area deform and that the joining portion 318′ gets disjoined and released open. Further, the reinforcing member 160a′ is adapted to fit in the whole of the depression 312′ of the shield case 300′, further improving the prying resistance of the connector compared to the connector of the first embodiment. Further, the reinforcing member 160a′ projects from the front surface of the main body 110a′ of the first body 100a, the reinforcing member 160a′ can be fitted in the depression 312′ of the shield case 300′ when inserting the first and second bodies 100a′, 100b′ into the shield case 300′. This configuration can reduce assembling man-hours of the present connector. The connector also produces some other advantageous effects as in the receptacle connector of the first embodiment.

The above-described receptacle connector is not limited to the above-described embodiment, but it may be modified in design within the scope of claims. Examples of modifications are described more in detail below.

The shield case according to the first and second embodiments is a press-molded conductive metal plate, but the shield case may be modified in design as long as it is tuboid and has an internal space for accommodating a body. For example, the shield case may be formed of insulating resin or ceramic material in a tuboid shape, the outer surface of which may be deposited with metal. Alternatively, the shield case may be of conductive metal cast into a tuboid shape.

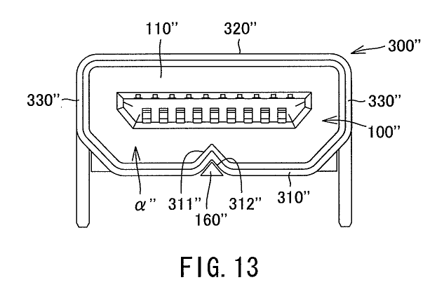

In the first and second embodiments, the bent portion of the bottom plate is bent inside the shield case and extends through from the front end (first end) to the rear end (second end) in the insertion direction of the bottom plate of the shield case, and the bent portion functions as a partition to partition the internal space of the shield case into the first and second slots. However, the bent portion may be modified in design as long as it is formed by bending a part of the shield case inward and extends in the insertion direction of the body. For example, the bent portion may be provided in the top plate or one of the side plates. The bent portion may or may not extend through from the front end (first end) to the rear end (second end) in the insertion direction of the bottom plate, the top plate or one of the side plates of the shield case. Further alternatively, as in a connector as shown in FIG. 13, a bent portion of a bottom plate 310″ of a shield case 300″ may be used as a key portion 311″ to fit in a key groove of a mating connector. Engagement of the key portion 311″ in the key groove can prevent insertion of a nonconforming connector, such as ones with no key groove or with a different type of key groove. If the bent portion is used as the key portion 311″, a reinforcing member 160″ projecting from a front surface in the insertion direction of a main body 110″ of a body 100″ may fit in at least a part of a depression 312″ on the back side of the key portion 311″, so that the key portion 311″ is reinforced, providing similar effects to those in the first and second embodiments. Further, the bent portion may not function as the partition or the key portion, but it may be provided for another role or just for an ornamental purpose. FIG. 13 also illustrates a top plate 320″ and side plates 330″.

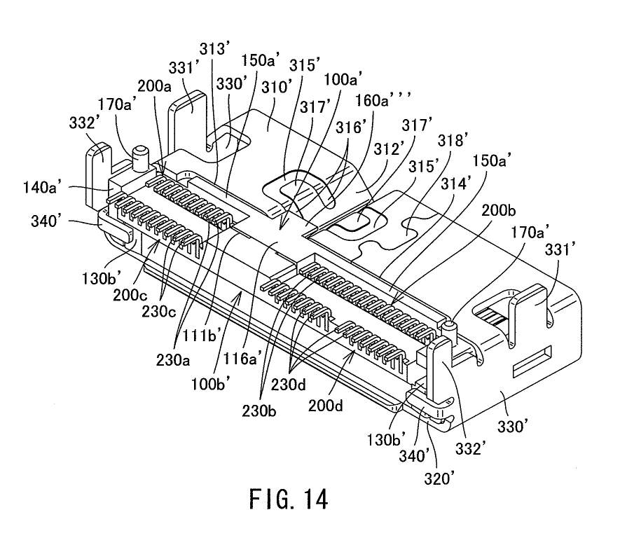

The reinforcing member of the first embodiment fits in a part of the depression on the back side of the bent portion, and the reinforcing member of the second embodiment fits in the whole of the depression on the back side of the partition. However, the reinforcing member of the invention needs to fit in at least a part of the depression on the back side of the bent portion. For example, FIG. 14 illustrates a reinforcing member 160a″′ of a smaller length in the insertion direction γ than the length in the insertion direction γ of the depression 312′, so that the reinforcing member 160a″′ fits in a part of the depression 312′. Moreover, the reinforcing member may or may not project from the front surface in the insertion direction of the first body. For example, a reinforcing member may be separately provided from the body to fit in the depression on the back side of the bent portion. Moreover, the reinforcing member may be made of harder material, e.g. metallic and ceramic materials, than that of the body. The reinforcing member may be attached to the body by press-fitting it into a bore opened in the body or by insert-molding it into the body.

The shield case of the first and second embodiments has the first and second slots, but may be modified as shown in FIG. 13, where a shield case 300″ has only one slot α″. Alternatively, the shield case may have three or more slots, by providing a plurality of bent portions, attaching separately formed partition plates to the inside of the shield case, or providing both the bent portion(s) and the partition plate(s). In the cases where the shield case has a plurality of slots, the internal space of the shield case may be partitioned with the partition plate, and the bent portion of the shield case may be used as the key portion or the like.

In the first and second embodiments, the first and second recesses defining the pads are provided in the boundary areas between the outer surface of the bottom plate and the inner surfaces of the lower depressed portion. However, the first and second recesses may be provided anywhere, as long as they are provided in boundary areas between two continuing surfaces of the shield case at an angle or at a right angle with respect to each other. For example, the outer surfaces of the side plates of the shield case may be arranged at an angle or at a right angle with respect to the outer surface of the bottom plate, and the first and second recesses may be provided in boundary areas between the outer surface of the bottom plate and the outer surfaces of the side plates. The second recesses are generally rectangular in the first and second embodiments, but they may be of any shape as long as they communicate with first and second end portions of the first recesses. For example, the second recesses may be curved such that their ends communicate with each other. The pads as described in the first and second embodiment are described by way of example only, and they may be modified in accordance with the shapes of the first and second recesses. The first and second recesses and the pads may be omitted when deemed unnecessary.

The present invention is not limited to the first and second embodiments where the shield case has the pair of front terminals and the pair of rear terminals. The front terminals and the rear terminals may be omitted, and only the front terminals or the rear terminals may be provided.

The connector in the first and second embodiments includes the first and second bodies, but the connector of the present invention requires at least one body. The connector of the invention requires at least one type of contacts. The contacts may not be embedded in the body but may be inserted into holes formed in the body. The tail portions of the contacts are arrayed in the two anteroposterior rows in the insertion direction in the first and second embodiments, but they may be arrayed in a row. Moreover, the tail portions may extend downward to be connected to the through-hole electrodes of the circuit board.

The materials, shapes, numbers, dimensions etc. of the respective elements of the receptacle connector in the first and second embodiments have been described by way of example only, and they may be modified in design in any manner as long as they provide similar functions. The present invention is not limited to the connectors described in the first and second embodiments where the first slot is compliant with the HDMI Type D standard and the second slot is compliant with a standard other than HDMI. The first and second slots may be modified in design in accordance with the mating connector so as to comply with any standard including other HDMI standards than Type D standard. For example, the first and second slots have the same internal shape so as to receive with mating connectors of the same type. Furthermore, the present invention is applicable not only to receptacle connectors but also to plug connectors with a cable connected to an end of a circuit board. Moreover, the television receiver is mentioned above as exemplifying the electronic equipment, but the present invention is not limited thereto.

### REFERENCE SIGNS LIST

10 circuit board
20 plug connector
30 plug connector
40 plug connector
100a first body
160a reinforcing member
100b second body
200a first contact
200b second contact
200c third contact
200d fourth contact
300 shield case
310 bottom plate
311 partition (bent portion)
312 depression (depressed surface of partition)
318 joining portion

1. A connector comprising:
a body having an insulating property;
a contact provided in the body;
a tuboid shield case adapted to receive the body; and
a reinforcing member, wherein
the shield case includes:
a bent portion, being a portion of the shield case bent inward and extending in an insertion direction of the body; and
a depression, being provided on a backside of the bent portion and extending in the insertion direction, and
the reinforcing member is configured to fit in at least a part of the depression.

2. The connector according to claim 1, wherein the reinforcing member is configured to fit in a whole of the depression.

3. The connector according to claim 1, wherein
the body includes a first surface in the insertion direction and a second surface on an opposite side of the first surface in the insertion direction, and
the reinforcing member projects from the first surface of the body.

4. The connector according to claim 2, wherein
the body includes a first surface in the insertion direction and a second surface on an opposite side of the first surface in the insertion direction, and
the reinforcing member projects from the first surface of the body.

5. The connector according to claim 1, wherein the bent portion partitions an internal space of the shield case into first and second slots.

6. The connector according to claim 1, wherein the bent portion functions as a key portion that is insertable into a key groove of a mating connector.

7. The connector according to claim 5, wherein the shield case is an electrically conductive plate bent into a tuboid shape, the shield case further includes a joining portion formed by joining end portions of the plate.

8. The connector according to claim 6, wherein the shield case is an electrically conductive plate bent into a tuboid shape, the shield case further includes a joining portion formed by joining end portions of the plate.

9. Electronic equipment comprising the connector according to claim 1 as an external interface.
